(19) United States
(12) Patent Application Publication
(10) Pub. No.: US 2025/0286777 A1
(43) Pub. Date: Sep. 11, 2025

(54) ORCHESTRATING DEPLOYMENT OF A SERVICE IN CLOUD INFRASTRUCTURES

(71) Applicant: Nokia Solutions and Networks Oy, Espoo (FI)

(72) Inventors: Vincent VERDOT, Massy (FR); Pierre PELOSO, Massy (FR)

(21) Appl. No.: 19/065,688

(22) Filed: Feb. 27, 2025

(30) Foreign Application Priority Data
Mar. 11, 2024 (FI) 20245293

(51) Int. Cl. H04L 41/0806; G06F 8/60; H04L 41/0816

(52) U.S. Cl. CPC H04L 41/0806; G06F 8/60; H04L 41/0816

(57) ABSTRACT

A service description is provided to an orchestration function for a service to be deployed over at least one infrastructure of a plurality of infrastructures having respective access points. At least one of the plurality of software components to be deployed is tagged in the service description as being a replicable component adapted to be replicated in two or more of the plurality of infrastructures. The deployment is orchestrated by determining whether to replicate a replicable component and in which infrastructures based on a performance estimation function evaluated for a set of end devices of interest and candidate instances of the plurality of software components. The performance estimation function varies in dependence of (i) candidate infrastructures for deploying the candidate instances and (ii) one or more infrastructures to which the end devices of interest are respectively connected via an access point.

### TECHNICAL FIELD

Various examples relate generally to a method for orchestrating deployment of a service in cloud computing infrastructure, a method for requesting deployment of a service and associated apparatuses.

### BACKGROUND

Cloud computing infrastructures using edge computing or fog computing must carry service deployment to end devices, e.g., IoT (Internet of Things) devices, using cloud computing infrastructures. The intrinsic volatility of IoT devices (due to their mobility and/or unreliable connectivity) imposes high constraints on orchestration mechanisms.

This difficulty increases when the service to be deployed is a complex application (e.g., a micro-services based application) that includes many software components, e.g., loosely-coupled pieces of execution code.

Additionally, the cloud computing infrastructures may be both decentralized and multi-owned (e.g., multi-stakeholder edge network infrastructures), requiring a collaboration of multiple access networks and/or network domains to connect end devices to the requested services.

### SUMMARY

The scope of protection is set out by the independent claims. The embodiments, examples and features, if any, described in this specification that do not fall under the scope of the protection are to be interpreted as examples useful for understanding the various embodiments or examples that fall under the scope of protection.

According to a first aspect, a method comprises: receiving, by an orchestration function, a service description for a service to be deployed over at least one infrastructure of a plurality of infrastructures having respective access points, wherein the service description includes a plurality of software components to be deployed for providing the service, wherein at least one of the plurality of software components is tagged in the service description as being a replicable component adapted to be replicated in two or more of the plurality of infrastructures; orchestrating, by the orchestration function, a deployment of the plurality of software components in the at least one infrastructure on the basis of the service description in order to provide the service to a plurality of end devices; wherein orchestrating the deployment includes determining whether to replicate a replicable component and in which infrastructures based on a performance estimation function evaluated for a set of end devices of interest and candidate instances of the plurality of software components; wherein the performance estimation function varies in dependence of (i) candidate infrastructures for deploying the candidate instances and (ii) one or more infrastructures to which the end devices of interest are respectively connected via an access point.

The performance estimation function may be evaluated based on performance estimates obtained respectively for the candidate instances; wherein a performance estimate for a given candidate instance of a software component to be deployed in a candidate infrastructure varies in dependence upon the candidate infrastructure in which the given candidate instance is to be deployed and the one or more infrastructure to which the one or more end devices of interest to be served by the given candidate instance are respectively connected.

The performance estimate for the given candidate instance may vary in dependence upon at least one performance metric, the at least one performance metric including a distance between the end device of interest and the given candidate instance to be deployed for serving the end device of interest.

The service description may define the performance estimation function.

Orchestrating the deployment of the plurality of software components may comprise: selecting respective locations in candidate infrastructures for deploying the candidate instances of the plurality of software components for providing the service to the set of end devices of interest, wherein selecting the respective locations is performed so as to meet performance requirements based on the performance estimation function.

Selecting the respective locations may comprise: generating sets of candidate instances adapted for providing the service to end devices of interest, wherein each of the sets of candidate instances comprises one or more candidate instances for each replicable component in the plurality of software components and only one candidate instance for each non-replicable component in the plurality of software components, wherein a candidate instance in a set of candidate instances is assigned to at least one of the end devices of interest to be served by the considered candidate instance; generating a performance estimate for each candidate instance in the sets of candidate instances and the one or more end devices of interest to be served by the considered candidate instance; selecting one of the sets of candidate instances for which the performance estimates of the candidate instances in the considered set of candidate instances meet the performance requirements; deploying the service using the candidate instances of the selected set of candidate instances.

The service description may define one set of at least one end device of interest for the plurality of software components.

The service description may define a set of end devices of interest per replicable software component and an associated performance estimation function; wherein the performance estimation function is evaluated independently for each replicable component over candidate instances of the considered replicable component for serving the considered set of end devices of interest.

The method may comprise: determining whether to replicate a replicable component or delete an instance of a replicable component in response to a detection of at least one of the following triggers: a connection to an infrastructure of an end device of interest, a disconnection from an infrastructure of an end device of interest, a change of access point for an end device of interest, an update of the definition of the set of end devices of interest; wherein determining whether to replicate a replicable component or delete an instance of a replicable component is performed based on results of the performance estimation function evaluated after the detection of the at least one trigger.

The method may comprise: evaluating the performance estimation function in response to a detection of at least one of the followings changes: a connection to an infrastructure of an end device of interest, a disconnection from an infrastructure of an end device of interest, a change of access point for an end device of interest, an update of the definition of the set of end devices of interest, an update of a definition of the performance estimation function, an update in the plurality of software components to de deployed for providing the service; determining whether to replicate a replicable component or delete an instance of a replicable component based on results of the evaluation of the performance estimation function.

According to another aspect, an apparatus comprises means for: receiving, by an orchestration function, a service description for a service to be deployed over at least one infrastructure of a plurality of infrastructures having respective access points, wherein the service description includes a plurality of software components to be deployed for providing the service, wherein at least one of the plurality of software components is tagged in the service description as being a replicable component adapted to be replicated in two or more of the plurality of infrastructures; orchestrating, by the orchestration function, a deployment of the plurality of software components in the at least one infrastructure on the basis of the service description in order to provide the service to a plurality of end devices; wherein orchestrating the deployment includes determining whether to replicate a replicable component and in which infrastructures based on a performance estimation function evaluated for a set of end devices of interest and candidate instances of the plurality of software components; wherein the performance estimation function varies in dependence of (i) candidate infrastructures for deploying the candidate instances and (ii) one or more infrastructures to which the end devices of interest are respectively connected via an access point.

The means may be adapted for performing one or more or all steps of the method according to the first aspect. The means may include at least one processor and at least one memory storing instructions that, when executed by the at least one processor, cause the apparatus to perform one or more or all steps of a method according to the first aspect. The means may include circuitry (e.g., processing circuitry) to perform one or more or all steps of a method according to the first aspect.

The instructions, when executed by the at least one processor, may cause the apparatus to perform one or more or all steps of a method according to the first aspect.

According to another aspect, a computer program comprises instructions that, when executed by an apparatus, cause the apparatus to perform: receiving, by an orchestration function, a service description for a service to be deployed over at least one infrastructure of a plurality of infrastructures having respective access points, wherein the service description includes a plurality of software components to be deployed for providing the service, wherein at least one of the plurality of software components is tagged in the service description as being a replicable component adapted to be replicated in two or more of the plurality of infrastructures; orchestrating, by the orchestration function, a deployment of the plurality of software components in the at least one infrastructure on the basis of the service description in order to provide the service to a plurality of end devices; wherein orchestrating the deployment includes determining whether to replicate a replicable component and in which infrastructures based on a performance estimation function evaluated for a set of end devices of interest and candidate instances of the plurality of software components; wherein the performance estimation function varies in dependence of (i) candidate infrastructures for deploying the candidate instances and (ii) one or more infrastructures to which the end devices of interest are respectively connected via an access point.

The instructions may cause the apparatus to perform one or more or all steps of a method according to the first aspect.

According to another aspect, a non-transitory computer readable medium comprises program instructions stored thereon for causing an apparatus to perform at least the following: receiving, by an orchestration function, a service description for a service to be deployed over at least one infrastructure of a plurality of infrastructures having respective access points, wherein the service description includes a plurality of software components to be deployed for providing the service, wherein at least one of the plurality of software components is tagged in the service description as being a replicable component adapted to be replicated in two or more of the plurality of infrastructures; orchestrating, by the orchestration function, a deployment of the plurality of software components in the at least one infrastructure on the basis of the service description in order to provide the service to a plurality of end devices; wherein orchestrating the deployment includes determining whether to replicate a replicable component and in which infrastructures based on a performance estimation function evaluated for a set of end devices of interest and candidate instances of the plurality of software components; wherein the performance estimation function varies in dependence of (i) candidate infrastructures for deploying the candidate instances and (ii) one or more infrastructures to which the end devices of interest are respectively connected via an access point.

The program instructions may cause the apparatus to perform one or more or all steps of a method according to the first aspect.

According to a second aspect, a method comprises: transmitting, to an orchestration function, a service description for a service to be deployed over at least one infrastructure of a plurality of infrastructures, wherein the service description includes a plurality of software components to be deployed for providing the service, wherein at least one of the plurality of software components is tagged in the service description as being a replicable component adapted to be replicated in two or more of the plurality of infrastructures; requesting a deployment of the plurality of software components in the at least one infrastructure on the basis of the service description in order to provide the service to one or more end devices, the service description including a performance estimation function to be evaluated over candidate instances of the plurality of software components and a set of end devices of interest in order to determine whether to replicate a replicable component and in which infrastructures; wherein the performance estimation function takes into account (i) candidate infrastructures assigned to the candidate instances and (ii) one or more infrastructures to which the end devices of interest are respectively connected.

According to another aspect, an apparatus comprises means for: transmitting, to an orchestration function, a service description for a service to be deployed over at least one infrastructure of a plurality of infrastructures, wherein the service description includes a plurality of software components to be deployed for providing the service, wherein at least one of the plurality of software components is tagged in the service description as being a replicable component adapted to be replicated in two or more of the plurality of infrastructures; requesting a deployment of the plurality of software components in the at least one infrastructure on the basis of the service description in order to provide the service to one or more end devices, the service description including a performance estimation function to be evaluated over candidate instances of the plurality of software components and a set of end devices of interest in order to determine whether to replicate a replicable component and in which infrastructures; wherein the performance estimation function takes into account (i) candidate infrastructures assigned to the candidate instances and (ii) one or more infrastructures to which the end devices of interest are respectively connected.

The means may be adapted for performing one or more or all steps of the method according to the second aspect. The means may include at least one processor and at least one memory storing instructions that, when executed by the at least one processor, cause the apparatus to perform one or more or all steps of a method according to the second aspect. The means may include circuitry (e.g., processing circuitry) to perform one or more or all steps of a method according to the second aspect.

The instructions, when executed by the at least one processor, may cause the apparatus to perform one or more or all steps of a method according to the second aspect.

According to another aspect, a computer program comprises instructions that, when executed by an apparatus, cause the apparatus to perform: transmitting, to an orchestration function, a service description for a service to be deployed over at least one infrastructure of a plurality of infrastructures, wherein the service description includes a plurality of software components to be deployed for providing the service, wherein at least one of the plurality of software components is tagged in the service description as being a replicable component adapted to be replicated in two or more of the plurality of infrastructures; requesting a deployment of the plurality of software components in the at least one infrastructure on the basis of the service description in order to provide the service to one or more end devices, the service description including a performance estimation function to be evaluated over candidate instances of the plurality of software components and a set of end devices of interest in order to determine whether to replicate a replicable component and in which infrastructures; wherein the performance estimation function takes into account (i) candidate infrastructures assigned to the candidate instances and (ii) one or more infrastructures to which the end devices of interest are respectively connected.

The instructions may cause the apparatus to perform one or more or all steps of a method according to the second aspect.

According to another aspect, a non-transitory computer readable medium comprises program instructions stored thereon for causing an apparatus to perform at least the following: transmitting, to an orchestration function, a service description for a service to be deployed over at least one infrastructure of a plurality of infrastructures, wherein the service description includes a plurality of software components to be deployed for providing the service, wherein at least one of the plurality of software components is tagged in the service description as being a replicable component adapted to be replicated in two or more of the plurality of infrastructures; requesting a deployment of the plurality of software components in the at least one infrastructure on the basis of the service description in order to provide the service to one or more end devices, the service description including a performance estimation function to be evaluated over candidate instances of the plurality of software components and a set of end devices of interest in order to determine whether to replicate a replicable component and in which infrastructures; wherein the performance estimation function takes into account (i) candidate infrastructures assigned to the candidate instances and (ii) one or more infrastructures to which the end devices of interest are respectively connected.

The program instructions may cause the apparatus to perform one or more or all steps of a method according to the second aspect.

### BRIEF DESCRIPTION OF THE DRAWINGS

Examples will become more fully understood from the detailed description given herein below and the accompanying drawings, which are given by way of illustration only and thus are not limiting of this disclosure.

FIG. 1 is a block diagram of a system according to an example.

FIG. 2 shows a flowchart of a method for deployment of a service according to an example.

FIG. 3A-3D shows successive deployment states along the execution of a deployment according to an example.

FIG. 4 shows a flowchart of a method for orchestrating deployment of a service according to an example.

FIG. 5 shows a flowchart of a method for orchestrating deployment of a service according to an example.

FIG. 6 shows a flowchart of a method for requesting orchestration of a deployment of a service according to an example.

FIG. 7 is a block diagram illustrating an exemplary hardware structure of an apparatus according to an example.

It should be noted that these drawings are intended to illustrate various aspects of devices, methods and structures used in examples described herein. The use of similar or identical reference numbers in the various drawings is intended to indicate the presence of a similar or identical element or feature.

### DETAILED DESCRIPTION

Detailed examples are disclosed herein. However, specific structural and/or functional details disclosed herein are merely representative for purposes of describing examples and providing a clear understanding of the underlying principles. However these examples may be practiced without these specific details. These examples may be embodied in many alternate forms, with various modifications, and should not be construed as limited to only the embodiments set forth herein. In addition, the figures and descriptions may have been simplified to illustrate elements and/or aspects that are relevant for a clear understanding of the present invention, while eliminating, for purposes of clarity, many other elements that may be well known in the art or not relevant for the understanding of the invention.

A method for orchestrating deployment of a service over multiples infrastructures (e.g., cloud computing infrastructures) having respective access points is disclosed.

A service may take the form of an application based on multiple software components, each offering a so-called “micro-service” based on a micro-service framework. In a micro-service framework, each software component of the service needs to be executed and configured such that inter-components communication is available and operative and that the overall service works as expected using the micro-service framework.

In examples, orchestration mechanisms are provided to dynamically reconfigure service deployments to match local resources available in the cloud computing infrastructures and the connectivity of the end devices. This allows to adapt the deployment of a service to match the list of end devices currently using the service when end devices “dynamically” connect or disconnect and/or when a change of access points of end devices happens.

In examples, to deploy a new application, a user generates a service description that may list the required software components, set(s) of end devices of interest, along with performance requirements. The performance requirements may be defined based on performance estimation function(s) and/or performance metric(s) that will be used to measure performance of instances of software component. The service description may be dynamically updated. For example the set(s) of end devices of interest and/or the performance requirements may be dynamically updated.

In examples, dynamic replication and/or relocation of one or more replicable software components may be performed to meet performance requirements (e.g., an optimization criterion) that may be evaluated dynamically on the basis of a performance estimation function. Decision of replication and/or relocation of instance(s) of software component(s) to an infrastructure or another or duplication of instance(s) of software component(s) it is taken by an orchestration function based on performance requirements that may be defined in a service description.

In examples, after an initial deployment, the performance estimation function can lead the orchestration function to dynamically reconfigure the application into a new deployment setup, by replicating and/or relocating instance(s) of software component(s) according to the performance requirements.

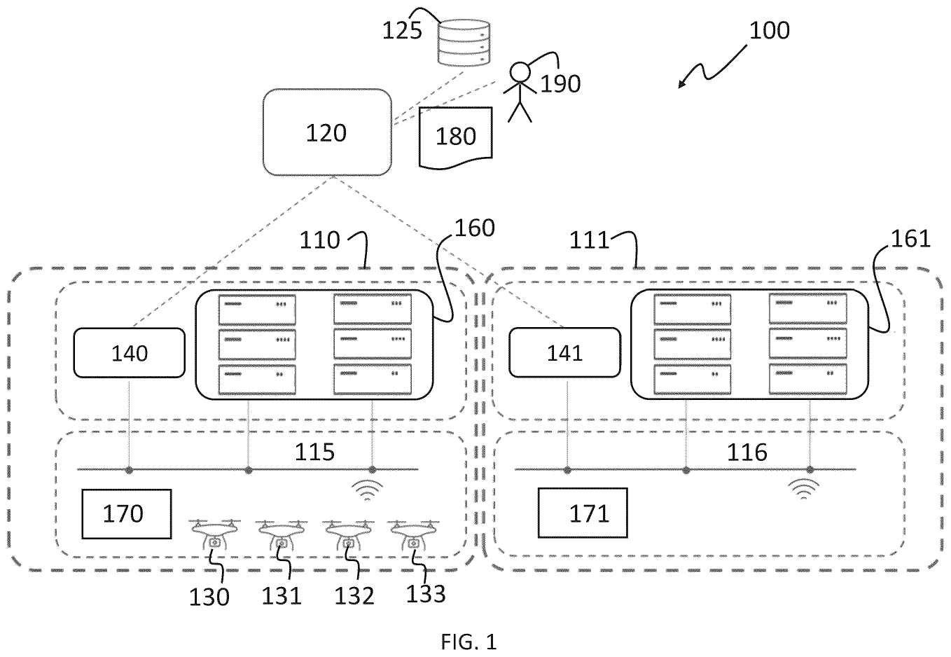

FIG. 1 is a block diagram of a system 100 according to an example. The system 100 includes infrastructures 110, 111 (e.g., cloud computing infrastructures) and an orchestration function 120 configured to orchestrate deployment of at least one service. The orchestration function 120 may be associated with or may include a database 125. While the figure represents only two infrastructures 110, 111 for simplicity and readability reasons, the present description can easily be generalized to any number of infrastructures.

Each infrastructure 110, 111 has its own access points and/or access network 115, 116 adapted to provide connectivity to end devices 130, 131, 132, 133 to this given infrastructure.

A given infrastructure 110, 111 may be owned and/or managed by a respective business entity. In embodiments, a given infrastructure 110, 111 may correspond to a network of interconnected devices such that two distinct infrastructures have no interconnected devices. In embodiments, a given infrastructure may correspond to a network domain. A given infrastructure may correspond to a sub-infrastructure of a large infrastructure. A given infrastructure 110, 111 may correspond to an infrastructure or sub-infrastructure having specific management rules, distinct from management rules of the other infrastructures or sub-infrastructures.

An end device (or terminal device or user device) 130, 131, 132, 133 may be a computing device that includes a transceiver for wired or wireless communication, the computing device operating with or without a subscriber identification module (SIM). An end device may be for example: a radio cell phone, a smartphone, a personal digital assistant, a handset, a measurement device, a laptop, a personal computer, a tablet, a phablet, a game console, a notebook, a multimedia device, as examples. An end device may also be any communicating object, having capability to operate in an Internet of Things (IoT) network and to transfer data over a network without requiring human-to-human or human-to-computer interaction. Example communicating objects include: printer, fridge, coffee maker, thermometer, robot, drone, sensor, actuator, watch, etc.

Each service to be deployed corresponds to a software application (e.g., a micro-services application) including a plurality of software components, where the software application is configured to provide the service to a plurality of end devices. An end device may be configured for example to send data to a software component and/or receive data from a software component, such data exchange being part of the service.

A given infrastructure 110, 111 may include at least one set (e.g., a cluster 160, 161) of computing nodes, each computing node being adapted to execute one or more software components (e.g., using service-oriented architecture, SoA) for one or more software applications.

Each of the infrastructures may include, beside a core cloud computing infrastructure, extension sub-infrastructure(s), like a fog computing sub-infrastructure and/or an edge computing sub-infrastructure. Fog computing takes place between the core cloud computing infrastructure and the end-devices, but away (in physical distance) from end devices compared to the edge computing sub-infrastructure. Edge computing may take place right on the devices attached to end devices or on a gateway device that is physically close to end devices. In the case of edge computing sub-infrastructures, the orchestration function may be configured to collaborate with multiple edge computing sub-infrastructures to orchestrate locally available resources. Each infrastructure 110, 111 may for example include an edge controller node 140, 141 in an edge computing sub-infrastructure, the edge controller node 140, 141 being configured to communicate with the orchestration function 120. The edge controller node 140, 141 may be configured to receive instructions from the orchestration function 120 (which itself receives instructions from a user 190) or directly from a user 190 to perform local orchestration (e.g., low-level software orchestration) and local resource management for the infrastructure in which the edge controller node 140, 141 is located.

The orchestration function has access to the infrastructures 110, 111 and is aware (e.g., based on localization information stored in the database 125) of end devices currently connected to the infrastructures 110, 111 and their associated access points. The orchestration function may be in charge of handling the lifecycle (start, stop, etc) and synchronization of a software application.

In embodiments, one or more respective localization agents 170, 171 are used for each of the infrastructures 110, 111. The function of a localization agent may be implemented either by the infrastructure itself, or outside the infrastructures 110, 111 or be embedded within one or more end devices. A localization agent 170, 171 is configured to collect localization information of one or more end devices and to notify the orchestration function 120 with the collected localization information and/or to store the localization information of the end devices in a database 125. Each localization agent may be configured to dynamically update the localization information of the end devices as the end devices connect to an access point or disconnect from an access point. The database may be used to extract a set of end devices currently connected to a given infrastructure with their localization information.

The localization information for an end device may include: geographical localization (e.g., using GPS, Global Positioning System) of the end device and/or an identification of an access point (or a wired port) to which the end device is connected and/or a geographical distance between the end device and the access point to which the end device is connected.

The orchestration function 120 is configured to orchestrate deployment of one or more services, each service corresponding to a set of software components. The deployment of the plurality of software components of a software application may be performed on the basis of an associated service description 180. The orchestration function may be configured to control and/or manage (e.g., distribute) processing load of the computing nodes 160, 161 by assigning instances of software components to computing nodes and/or clusters in the infrastructures 110, 111.

To deploy a new software application, a user 190 (e.g., service administrator) generates a service description 180 that defines the required plurality of software components. The service description 180 may be sent by the user 190 to the orchestration function 120 configured to orchestrate deployment of the service.

The service description may be written in machine-readable file (for example using formats such as Json, XML, Yaml, etc). The file format may depend on the target infrastructure (e.g., the target micro-service framework) used for deploying the service.

The service description 180 defines (e.g., includes software code or references of software images of) the plurality of software components to be deployed for providing the service to end devices.

The service description 180 may define (e.g., include) performance requirements. For example, the service description 180 may include a performance estimation function (and/or performance metrics(s)) and/or an optimization criterion to be met when deploying the service. The service description 180 may for example include semantics to request use of performance metrics and specify performance requirements (or performance constraints). One or more specifically defined keywords may be used to define the performance requirements (e.g., at least one optimization criterion). The performance requirements (e.g., at least one optimization criterion) may be defined based on a performance estimation function and/or one or more performance estimation metric(s).

The orchestration method achieves dynamic replication of at least some of the software components tagged as being replicable components in the service description 180. A replicable component is a software component adapted to be replicated in two or more of the plurality of infrastructures, thereby using at least two instances of the replicable component to provide the service to end devices. A replicable component may also be replicated at different locations (e.g., in physically distinct computing nodes or physically distinct clusters, when multiple clusters 160 or multiple computing nodes exist at different locations) in a same infrastructure.

A software component that is not tagged as being replicable components in the service description 180 is a non-replicable component. A non-replicable component is a software component that is not adapted to be replicated: for such a non-replicable component only one instance can be deployed for providing the service to the plurality of end devices.

Orchestrating the deployment may be performed based on a performance estimation function evaluated over candidate instances of the plurality of software components and for a set of end devices of interest to be served by the set of candidate instances. The service description may define one or more sets of end devices of interest for which the evaluation of the performance estimation function is requested.

In embodiments, orchestrating deployment of the service includes determining whether to replicate a replicable component and in which infrastructures (or in which cluster or in which computing node) on the basis of a performance estimation function. Orchestrating deployment of the service may include assigning a location in an infrastructure (e.g., by assigning a cluster or a computing node to execute the instance) to an instance of software component (whether replicable or non-replicable), where the assigned infrastructure (or more precisely, the assigned cluster or computing node) will execute the instance.

The performance of several sets of candidate instances of the plurality of software components may be evaluated based on the performance estimation function in order to select one of the sets of candidate instances to be deployed for providing the service to the set of end devices of interest. Each of the sets of candidate instances to be deployed corresponds to a candidate deployment setup to be evaluated and a value of the performance estimation function is computed for each of the candidate deployment setup (i.e. for each of the sets of candidate instances).

Each of the sets of candidate instances comprises one or more candidate instances for each replicable component and only one candidate instance for each non-replicable component. A candidate instance in a set of candidate instances is assigned to one or more end devices of interest to be served by the considered candidate instance.

In embodiments, the performance estimation function may vary in dependence of the candidate infrastructures selected for deploying the candidate instances in a set. Especially, the performance estimation function may vary in dependence of the respective location (in an infrastructure, in a cluster of the infrastructure or in a computing node of the infrastructure) of the candidate instances in the candidate infrastructures selected for deploying the candidate instances in a set. The location may be defined with more or less accuracy: at infrastructure level, at cluster level or at computing node level: the location may identify a host infrastructure (or, more accurately, a host cluster, or host computing node).

The performance estimation function may vary in dependence upon the respective infrastructures (and/or clusters and/or computing nodes) in which the instances are to be deployed: depending on the granularity with which the performance estimation function is defined and evaluated, the location of the instances of the software components to be deployed may be determined and selected with more or less accuracy using the performance estimation function.

In embodiments, the performance estimation function may vary dynamically in dependence of the infrastructures to which the end devices of interest are respectively currently connected via an access point. Especially, the performance estimation function may vary dynamically in dependence of the access points via which the end devices of interest are respectively currently connected to an infrastructure.

The performance estimation function may be a connectivity-based performance estimation function that allows to dynamically optimize the location of the instances of the plurality of software components in the infrastructures by taking into account the access points via which the end devices of interest are respectively currently connected to an infrastructure. This optimization is performed globally for the set of end devices of interest over which the performance estimation function is evaluated.

The performance estimation function may be configured to evaluate the performance and/or efficiency with which the end devices of interest are connected to the software application through the instances of the software components.

The output value of the performance estimation function represents a global performance estimate (or global performance score) for a set of end devices of interest and for at least one software component, where a global performance estimate may be computed either per software component or for all software components depending on the optimization strategy.

The global performance estimate may be computed by mathematically combining (by a weighted or non-weighted sum, a weighted or non-weighted average, a multiplication, etc.) performance estimates at device and instance level, where each performance estimate at device and instance level is obtained for a pair consisting of (i) an instance of a software component and (ii) an end device served by this instance.

Each performance estimate at device and instance level is determined for a given candidate instance of a software component to be deployed in a candidate infrastructure, where the performance estimate varies in dependence upon the candidate infrastructure in which the given candidate instance is to be deployed (and optionally the localization in the candidate infrastructure) and the one or more infrastructure to which the end devices of interest to be served by the given candidate instance are respectively connected.

A performance estimate at device and instance level may be obtained based on one or more performance metrics evaluated for the communication link between the end device and the instance of a software component serving this end device.

The one or more performance metrics may include for example for the end device and the instance of a software component serving this end device:
a distance between the access point to which an end device is connected and the instance of a software component serving this end device;
a bandwidth available for serving the end device by using the instance of a software component;
a latency (or delay) in the communication link for serving the end device by using the instance of a software component;
a reliability (e.g., packet loss rate) of the communication link between the end device and the instance of a software component serving this end device;
a privacy of the communication link between the end device and the instance of a software component serving this end device;
an energy consumption of the communication link between the end device and the instance of a software component serving this end device;
a combined metric based on a combination of one or more of the above performance metrics.

The term “distance” used as performance metric has a meaning broader than pure geographical localization comparison and may take into account not only the geographical distance but also network routing constraints, like for example the number of network hops between the end device and the instance of a software component serving this end device.

The performance estimation function is used to generate a global performance estimate and defines how the performance estimates obtained at device and instance level are combined (added, weighted, multiplied, etc) to generate the global performance estimate, where a global performance estimate may be computed either per software component or for all software components depending on the optimization strategy.

By using one or more of the above performance metrics, it is possible to define a deployment strategy based on performance requirements (e.g., at least one optimization criterion). The performance requirements may be or include either a “proximity” criterion based on the distance or a connectivity-related criterion based on the connectivity-related metric or a QoE-based criterion to globally improve (or optimize) the quality of experience (QoE) based on one or more of the above metrics (e.g., distance, latency, bandwidth, reliability, privacy, energy consumption).

The performance requirements may for example define a deployment strategy that aims to reduce the latency and/or support high bandwidth and/or to deploy the service close to the end devices, preferably on the physical infrastructure which is offering connectivity to the end-devices via an access point.

A value of the performance estimation function may be computed for each deployment setup (or deployment option), where each deployment setup corresponds to a set of candidate instances of the plurality of software components to be deployed for serving the set of end devices of interest for providing the service.

An optimization criterion to be met for the set of end devices of interest may be defined. The optimization criterion may be applicable to the value(s) generated by the performance estimation function. The optimization criterion may be a minimization criterion, a maximization criterion, a performance criterion based on one or more thresholds applicable to the value of the performance estimation function or value(s) of one or more performance metric(s), etc.

The performance requirements may include for example a performance criterion such as “best match” (e.g., maximization of performance), “first match” (e.g., first deployment setup evaluated for which the performance is over a threshold), “cheapest-match” (e.g., minimization of costs) or “eco-match” (e.g., minimization of energy consumption), etc.

The performance estimation function may be evaluated dynamically, e.g., in real-time, to account for changes that may occur over time and/or upon request from a user (e.g., an service administrator) and/or according to a time schedule. For example, the performance estimation function may be evaluated:
when a connection to an infrastructure (respectively a disconnection from an infrastructure) is detected for an end device in the set of at least one end device of interest; and/or
when a change of access point is detected for an end device in the set of at least one end device of interest; and/or
when the definition of the performance estimation function is updated; and/or
when the plurality of software components included in the software application implementing the service is updated; and/or
when the service description 180 is updated; and/or
when the definition of the set of at least one end device of interest is updated; and/or
when a given time period has lapsed since the previous evaluation.

Triggers for determining (e.g., based on the performance estimation function and/or the performance requirements) whether to replicate of an instance of a replicable component (or symmetrically delete of an instance of a replicable component) may be either:
a connection to an infrastructure of an end device of interest: this infrastructure becomes a candidate infrastructure for locating an instance of one or more replicable components not currently hosted in this infrastructure; or
a disconnection from an infrastructure of an end device of interest: instances of one or more replicable components hosted in this infrastructure may be deleted; or
a change of access point and/or connecting infrastructure for an end device of interest such that an end device of interest is now connected to an infrastructure not currently hosting an instance of a replicable component and this infrastructure becomes a candidate infrastructure for locating an instance of one or more replicable components; or.
a user (e.g., service administrator) updating (augmenting or reducing) the set of end devices of interest such that the evaluation of the performance estimation function has to be done for the updated set of end devices of interest in order to meet the performance requirements.

A new deployment setup may be triggered based on the results of the evaluation of the performance estimation function in order to meet performance requirements (e.g., at least one optimization criterion) specified in the service description 180. Deploying a new deployment setup may include at least one of: (i) relocating an instance of a software component (whether replicable or not) (ii) adding an instance of a replicable component, (iii) deleting an instance of a replicable component.

Based on the results of the evaluation of the performance estimation function, the orchestration function is configured to select respective candidate infrastructures for deploying the candidate instances of the plurality of software components for providing the service to the end devices of interest. The selection is performed so as to meet the performance requirements.

In order to meet the performance requirements when orchestrating the deployment of a plurality of software components, several candidate deployment setups may be evaluated.

Each candidate deployment setup corresponds to a set of candidate instances of the plurality of software components to be evaluated. Each candidate deployment setup comprises at least one candidate instance of each of the plurality of software components so as to be able to provide the service to a set of end devices of interest.

For a non-replicable component, each of the candidate deployment setups comprises only one candidate instance of the considered non-replicable component. For a replicable component, each of the candidate deployment setups may comprise one or more candidate instances of the considered replicable component. There may be at least one candidate deployment setup that, for each replicable component, includes at least one candidate instance of the considered replicable component per infrastructure. A candidate instance in a set of candidate instances to be evaluated is further assigned for serving at least one of the end devices of interest.

Various algorithms may be used for generating the candidate deployment setups to be evaluated. The candidate deployment setups may be generated for example by generating a reference set of candidate instances including one instance of each replicable component in each infrastructure (or in each cluster) to which an end device is connected. A derived set of candidate instance(s) may be derived from the reference set by randomly selecting one or more (e.g., up to a maximum number) of the instance(s) of a replicated component in the reference set of candidate instances and by deleting the randomly selected instance(s) to obtain the derived set. This operation may be repeated a number of times until for example a given number of sets of candidate instances are generated. The performance estimation function is then evaluated for each set (whether the reference set or the derived sets).

Another example of candidate deployment setups generation could consist in creating a reference set of candidate instances including only one instance of each replicable component in the infrastructure (or cluster) to which the most end devices are connected. A derived set of candidate instance(s) may then be derived from the reference set by adding one instance of a replicated component to another infrastructure (if any) with the second most end devices connected to. The performance estimation function is then evaluated for the currently derived set and compared against the previous one and if the performance gain exceed a given (configured) value, then we continue deriving the candidate sets until there are no more infrastructures or the performance gain of the newly derived candidate deployment setup is lower that the defined threshold.

Once the candidate deployment setups have been generated, the orchestration function is configured to determine a performance estimate for each candidate deployment setup based on the performance estimation function. One of the candidate deployment setups that meets the performance requirements is selected by the orchestration function to be used for the deployment of a plurality of software components. The candidate instances of the selected candidate deployment setup are deployed. The orchestration function is configured to trigger the deployment and use of the candidate instances in the selected candidate deployment setup for providing the service to end devices currently connected to an infrastructure.

In embodiments, the service description may define a set of at least one end device of interest over which the performance estimation function is to be evaluated. The set of at least one end device of interest may be defined by device identifiers and/or by one or more conditions to be met by an end device to be part of the set of at least one end device of interest. A condition may be that the end device be currently connected to an infrastructure. Another condition may be that the end device be currently connected to given access point(s). Another condition may be a condition on the end device capabilities (such as e.g., capacity to stream music or to measure temperature or to display images, etc, . . . ), on end-devices criteria (such as e.g., this device being a sensitive one in terms of privacy or reliability), on the end-device status (such as e.g., availability at a given time), or on who is owning the end-device.

The set(s) of end devices of interest may be defined (e.g., either implicitly or explicitly) as being limited to end devices of interest that are currently connected to an infrastructure such that no performance estimate is necessary for the non-connected end devices of interest or the value of performance estimation function is not impacted by the non-connected end devices of interest.

In embodiments, the service description may define a set of at least one end device of interest per replicable software component. The performance estimation function is then evaluated independently for each replicable component for sets of candidate instance(s) of the considered replicable component so as to select a set of candidate instance(s) to be deployed for the considered replicable component.

The service description may also define the performance estimation function and/or performance criterion and/or performance metric(s) per replicable software component. The set of candidate instance(s) that meets the performance criterion associated with the considered replicable software component is in such case selected for deployment.

When deploying the various software components and connecting them with the end devices, the orchestration function uses the performance requirements of the service description to make decisions for placing instances of software components in the infrastructures, considering the availability of computing resources in the infrastructures, the infrastructure to which the end devices of interest are connected and the performance estimates evaluated as disclosed herein.

For example, when an end device moves from one infrastructure to another, the controller (e.g., the edge controller) of the target infrastructure may deploy a new instance of a replicable component in the target infrastructure to which an end device is newly connected through an access point. Likewise, when an end device moves from one access point to another within a same infrastructure, the controller (e.g., the edge controller) of the infrastructure may deploy a new instance of a replicable component in the concerned infrastructure to reduce or minimize the distance metric between the end device (or its access point) to the newly deployed instance of the replicable component.

Depending on the optimization strategy, the performance estimation function may be defined and evaluated either (i) independently for each software component over all end devices of interest served by the instance(s) of the considered software so as to meet the optimization criterion at component level (i.e. for each software component, whatever the number of instances used for this software component) or (ii) globally for all software components so as to meet the optimization criterion at service level.

A given instance of the software component (whether replicable or not) may serve one or several end devices. A non-replicable component is not replicated and only one instance will be located in only one infrastructure for serving all end devices of interest. A replicable component may be replicated at any time if this replication meets the performance requirements.

To meet the optimization criterion at component level for a non-replicable component, several candidate locations in infrastructures are evaluated based on performance estimates determined at device and instance level. The optimization criterion is to be met at component level for all end devices of interest, e.g., by computing a global performance estimate (e.g., as average performance estimate) over all end devices of interest for each candidate location of the non-replicable component and selecting a candidate location having a global performance estimate that meets the optimization criterion.

To meet the optimization criterion at component level for a replicable software component, several sets of one or more candidate instances having respective locations are evaluated to generate performance estimates at device and instance level as described herein. For the evaluation, a candidate instance in a set is assigned to one or more end devices of interest to be served by the considered candidate instance. Then a global performance estimate is computed for each set of one or more candidate instances. A set of one or more candidate locations that meets the optimization criterion is selected and the replicable component will be deployed using the one or more candidate instance of the selected set. If the selected set consists in only one instance, then the replicable software component will not be replicated. If the selected set includes more than one instance, then the replicable software component will be replicated using the instances in the selected set.

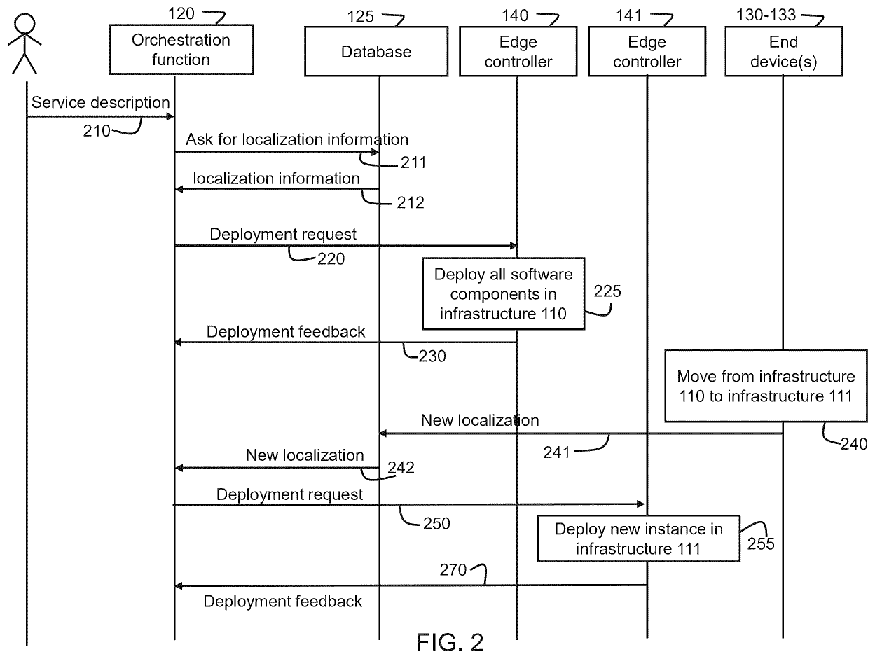

FIG. 2 shows a flowchart of a method for deployment of a service according to an example.

The steps of the method may be implemented by a system 100 disclosed by reference to FIG. 1, e.g., by an orchestration function 120, end devices 130-133 and edge controllers 140, 141.

While the steps are described in a sequential manner, the person skilled in the art will appreciate that some steps may be omitted, combined, performed in different order and/or in parallel.

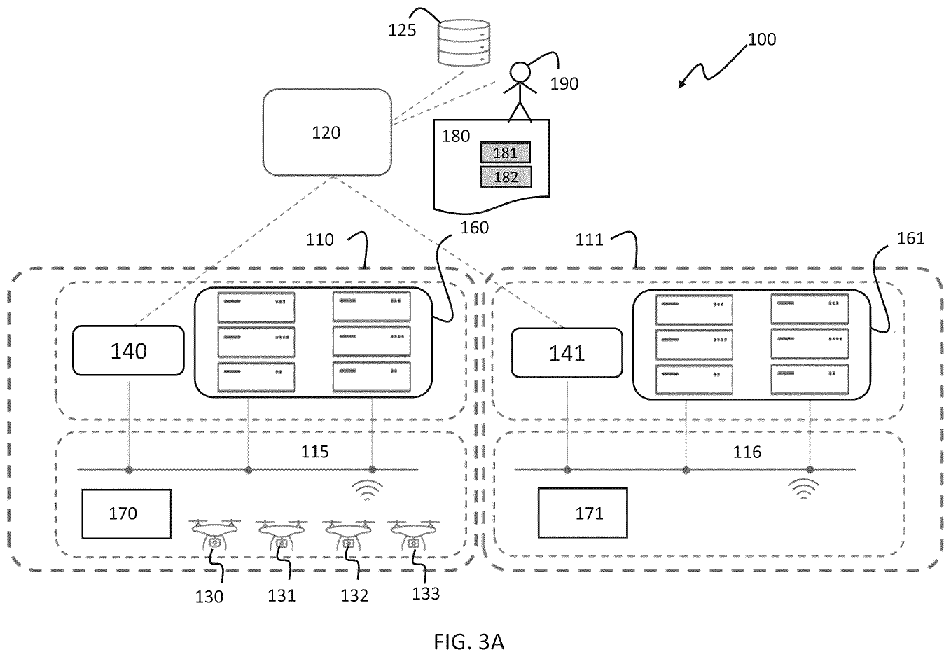

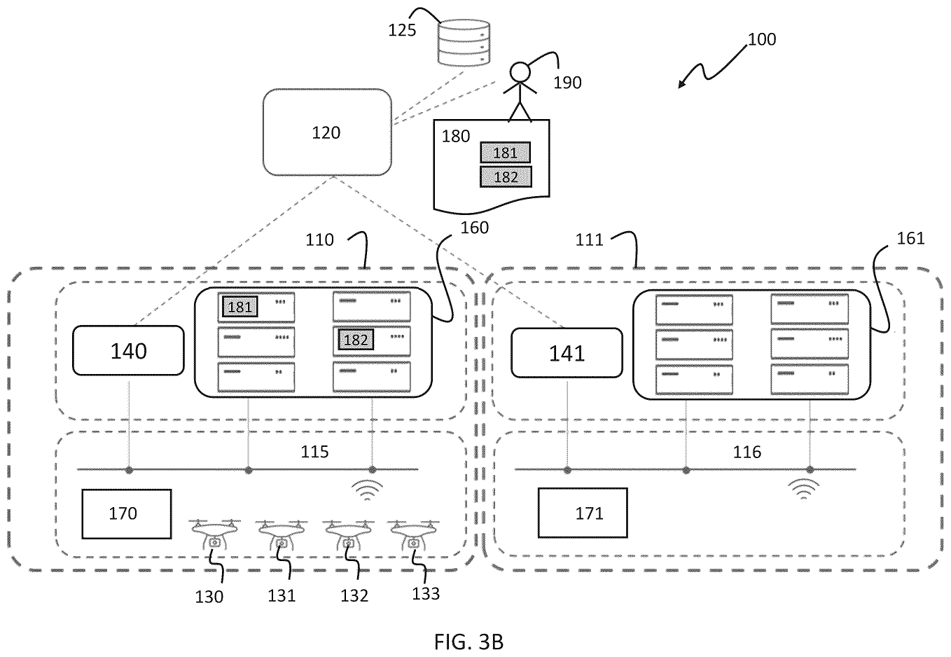

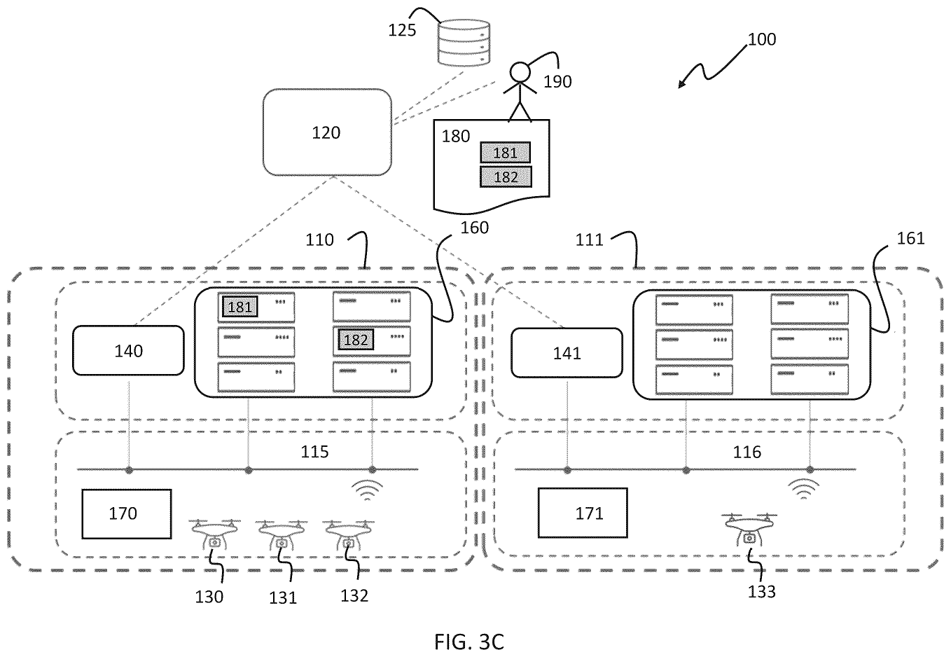

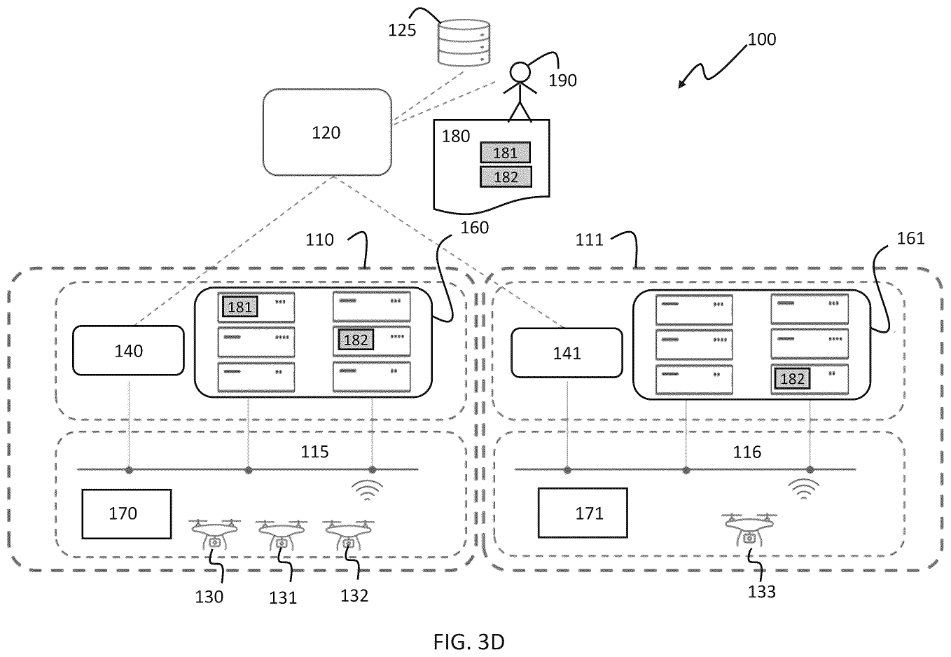

FIG. 3A-3B shows successive deployment states 1 to 4 of the system 100 during the execution of the method of FIG. 2.

In this example, two local infrastructures 110, 111 are used, both containing a cluster 160, 161 and a network domain 115, 116. The cluster 160, 161 can be a Kubernetes® cluster or any other micro-service framework. A primary orchestration function 120 is in communication with both infrastructures 110, 111. A user 190 addresses requests for deployment of a service to the orchestration function 120. A set of end devices of interest (defined for example as a list of participating devices 130-133) is provided by the user 190 to the orchestration function.

The sequence diagram of FIG. 2 illustrates how the replication of the components happens, and how each actor is participating in the process.

This initial deployment state of the scenario is deployment state 1 represented by FIG. 3A, where user 190 generates a service description. The service description defines two software components 181, 182, the first one 181 being a non-replicable component (i.e. a singleton), while the second one 182 is a replicable component. The service description further defines the list of participating devices 130-133. In deployment state 1 every participating device 130-133 is connected to the infrastructure 110.

The user sends (step 210) the service description to the orchestration function. The orchestration function needs localization of the participating devices in order to determine the placement of the software components 181, 182. An exchange (steps 211-212) with the database 125 is used to acquire the localization information for the participating devices 130-133.

Based on the receive localization information, the orchestration function 120 determines that deployment of the software components 181, 182 would better happen inside the cluster of the infrastructure 110 as every participating device 130-133 is connected to here, which triggers the sending (step 220) of a request to the edge controller 140 to deploy the two software components 181, 182. FIG. 3B shows the deployment state 2 after deployment (step 225) of the software components 181, 182. Optionally, the edge controller 140 may provide feedback (step 230) to the orchestration function 120 once deployment is completed by the edge controller 140.

After a steady state, deployment state 3 (represented in FIG. 3C) is reached, in which one of the participating devices 133 moves and connects (step 240) to infrastructure 111. The localization agent on the participating device 133 informs (step 241) the database 125 of its new localization. The database 125 may in turn inform (step 242) the orchestration function 120.

The orchestration function 120 is in charge of determining the need for replication when the orchestration function 120 is aware of new localization information. The evaluation is performed on the basis of a performance estimation function as disclosed herein.

Based on the results of the evaluation, the orchestration function 120 may request (step 250) to edge controller node 141 the additional deployment of a replicate of component 182 inside infrastructure 111. FIG. 3D shows the deployment state 4 after replication (step 255) of the software component 182. Optionally, the edge controller 141 may provide feedback (step 270) to the orchestration function 120 once deployment is completed by the edge controller 141.

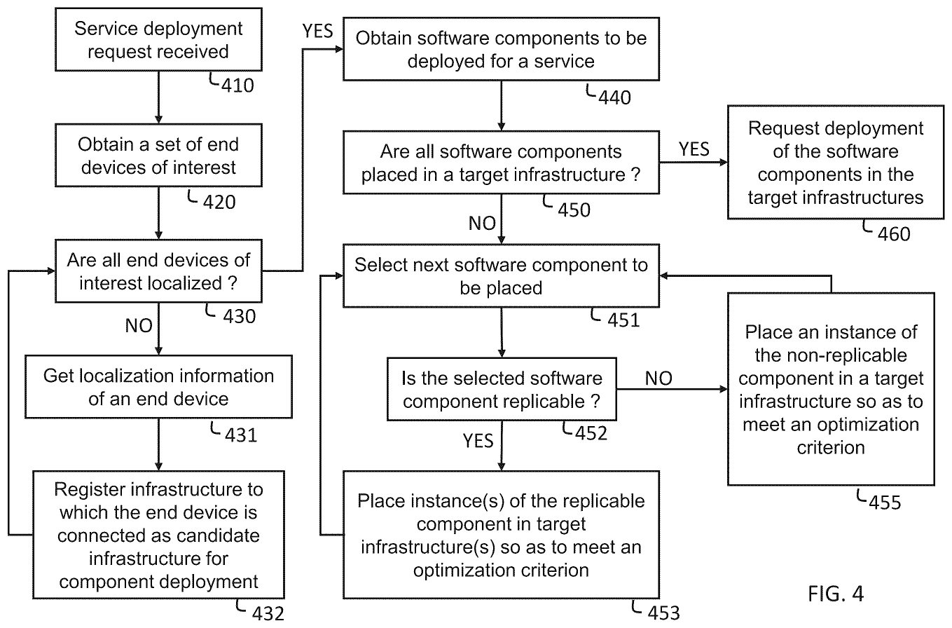

FIG. 4 shows a flowchart of a method for orchestrating deployment of a service according to an example.

The steps of the method may be implemented by an orchestration function 120 according to any example described herein.

While the steps are described in a sequential manner, the person skilled in the art will appreciate that some steps may be omitted, combined, performed in different order and/or in parallel.

In step 410, a service deployment request is received by the orchestration function. The service deployment request may include a service description as described herein.

In step 420, the orchestration function obtains a set of end devices of interest. The set of end devices of interest may be extracted from the service description.

In step 430, the orchestration function determines whether all end devices of interest are localized (whether localization information is available for all end devices of interest). If the response is YES, then step 440 may be executed after step 430. If the response is NO, then step 431 may be executed after step 430.

In step 431, the orchestration function obtains the localization information of a given end device that is not yet localized.

In step 432, the orchestration function registers the infrastructure to which the given end device is connected as candidate infrastructure for component deployment. Step 430 may be executed after step 432.

In step 440, the orchestration function obtains software components to be deployed for a service. The software components to be deployed for a service may be extracted from the service description as described herein.

In step 450, the orchestration function determines whether a location in a target infrastructure is assigned to all software components (i.e. whether all software components are placed in an infrastructure). If the response is YES, then step 460 may be executed after step 450. If the response is NO, then step 451 may be executed after step 450.

In step 451, the orchestration function selects a next software component to be placed in an infrastructure (i.e. a software component without assigned location in a target infrastructure).

In step 452, the orchestration function determines whether the selected software component is replicable. If the response is YES, then step 453 may be executed after step 452. If the response is NO, then step 455 may be executed after step 451.

In step 453, the orchestration function assigns respective location(s) in an infrastructure (e.g., a cluster or a computing node of the infrastructure) to one or more instances of the replicable component such that the global performance estimate for these one or more instances at the assigned location(s) meets an optimization criterion defined for example in the service description. The locations may be assigned such that there is at least one instance of the replicable component in each of the infrastructures to which at least one end device is connected.

The orchestration function may for example evaluate a plurality of candidate deployment setups, defining each a set of candidate instance(s) with respective assigned location(s). The orchestration function may for example obtains a performance estimate for each instance of the replicable component located in an infrastructure at a candidate location and for each end device of interest to be served by this instance and combine (add, sum, multiply, weight, etyc) these performance estimates so as to compute a global performance estimate for each candidate deployment setup. The orchestration function may then select the candidate deployment setup for which the performance estimate meets an optimization criterion defined in the performance requirements.

Step 451 may be executed after step 453.

In step 455, the orchestration function assigns a location in an infrastructure (e.g., in a cluster or a computing node of the infrastructure) to an instance of the non-replicable component such that the performance estimate for this instance at the assigned location meets an optimization criterion.

The orchestration function may for example obtains performance estimates for the considered instance of the non-replicable component, where a performance estimate is computed for several candidate locations of the instance in candidate infrastructures. As the non-replicable component will serve all end devices of interest without being replicated, the performance estimate for a given candidate location may be computed as the average performance estimate over all end devices of interest. The orchestration function may then select the candidate location for which the performance estimate meets an optimization criterion defined in the performance requirements and assign this optimum candidate location to the considered non-replicable component.

Step 451 may be executed after step 455.

In step 410, the orchestration function requests deployment of all software components in target infrastructures based on the locations assigned in step 453 or 455 to the respective instances of the software components.

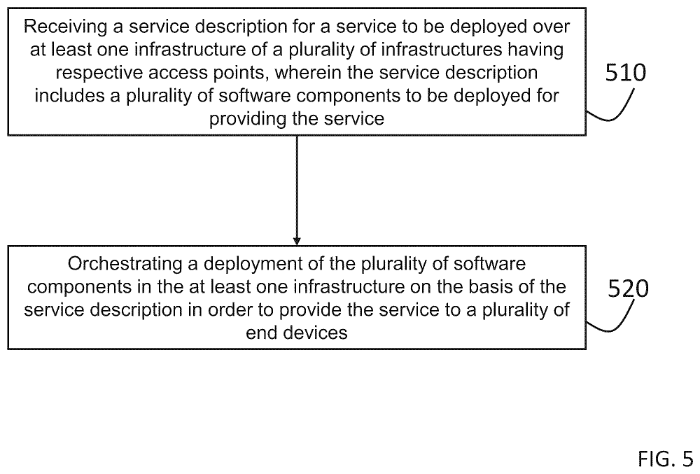

FIG. 5 shows a flowchart of a method for orchestrating deployment of a service according to an example.

The steps of the method may be implemented by an orchestration function 120 according to any example described herein.

While the steps are described in a sequential manner, the person skilled in the art will appreciate that some steps may be omitted, combined, performed in different order and/or in parallel.

In step 510 a service description is received for a service to be deployed over at least one infrastructure of a plurality of infrastructures having respective access points.

The service description may include a plurality of software components to be deployed for providing the service.

At least one of the plurality of software components may be tagged in the service description as being a replicable component adapted to be replicated in two or more of the plurality of infrastructures.

In step 520, a deployment of the plurality of software components in the at least one infrastructure is orchestrated on the basis of the service description in order to provide the service to a plurality of end devices.

Orchestrating the deployment may include determining whether to replicate a replicable component and in which infrastructures based on a performance estimation function evaluated for a set of end devices of interest and candidate instances of the plurality of software components.

Orchestrating the deployment of the plurality of software components may include selecting respective locations in candidate infrastructures for deploying the candidate instances of the plurality of software components for providing the service to the set of end devices of interest.

Selecting the respective locations may be performed so as to meet performance requirements (e.g., performance requirements defined on the basis of the performance estimation function).

For selecting the respective locations, the orchestration function may perform sets of generating sets of candidate instances adapted for providing the service to end devices of interest, where
each of the sets of candidate instances comprises one or more candidate instances for each replicable component in the plurality of software components and only one candidate instance for each non-replicable component in the plurality of software components, and
a candidate instance in a set of candidate instances is assigned to at least one of the end devices of interest to be served by the considered candidate instance.

The orchestration function may then generate a performance estimate for each candidate instance in the sets of candidate instances and the one or more end devices of interest to be served by the considered candidate instance.

A performance estimate for a candidate instance may be generated in any manner described herein.

The orchestration function may finally select one of the sets of candidate instances for which the performance estimates of the candidate instances in the considered set of candidate instances meet the performance requirements and deploy the service using the candidate instances of the selected set of candidate instances.

The performance estimation function may vary in dependence of (i) candidate infrastructures for deploying the candidate instances and (ii) one or more infrastructures to which the end devices of interest are respectively connected via an access point.

The performance estimation function may be defined in the service description.

The performance estimation function may be valuated according to any embodiment described herein.

In embodiments, the performance estimation function is evaluated based on performance estimates obtained respectively for candidate instances.

A performance estimate for a given candidate instance of a software component to be deployed in a candidate infrastructure may vary in dependence upon the candidate infrastructure in which the given candidate instance is to be deployed and the one or more infrastructure to which the one or more end devices of interest to be served by the given candidate instance are respectively connected.

A performance estimate for the given candidate instance may vary in dependence upon at least one performance metric, the at least one performance metric including a distance between the end device of interest and the given candidate instance to be deployed for serving the end device of interest.

Any other performance metric (e.g., latency, bandwidth, reliability, privacy, energy consumption) described herein may be used or combined for evaluating the performance estimation function.

In embodiments, the service description defines a set of end devices of interest per replicable software component and an associated performance estimation function: the performance estimation function is evaluated independently for each replicable component over candidate instances of the considered replicable component for serving the considered set of end devices of interest.

The method may include an optional step of evaluating the performance estimation function in response to a detection of at least one of the followings changes: a connection to an infrastructure of an end device of interest, a disconnection from an infrastructure of an end device of interest, a change of access point for an end device of interest, an update of the definition of the set of end devices of interest, an update of a definition of the performance estimation function, an update in the plurality of software components to de deployed for providing the service. The method may include an optional step of determining whether to replicate a replicable component or delete an instance of a replicable component based on the results of the evaluation of the performance estimation function.

The method may include an optional step of determining whether to replicate a replicable component or delete an instance of a replicable component in response to a detection of at least one of the following triggers: a connection to an infrastructure of an end device of interest, a disconnection from an infrastructure of an end device of interest, a change of access point for an end device of interest, an update of the definition of the set of end devices of interest. Determining whether to replicate a replicable component or delete an instance of a replicable component may be performed based on the results of the performance estimation function evaluated after the detection of the at least one trigger.

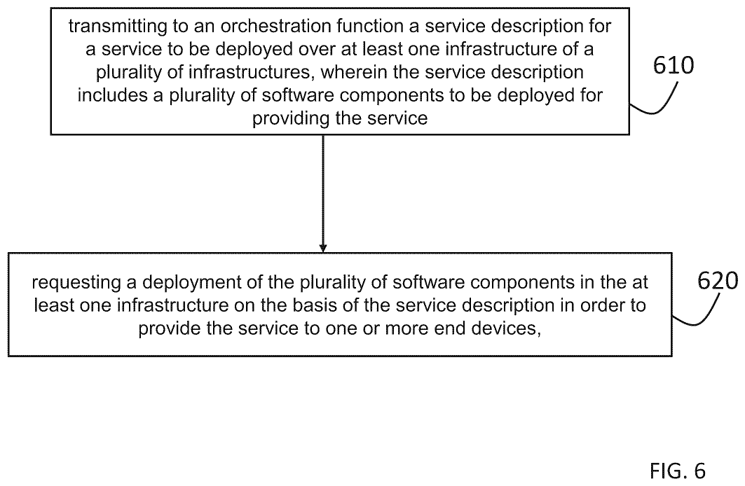

FIG. 6 shows a flowchart of a method for requesting orchestrating deployment of a service according to one or more examples. The steps of the method may be implemented by a user device in communication an orchestration function 120 according to any example described herein.

While the steps are described in a sequential manner, the person skilled in the art will appreciate that some steps may be omitted, combined, performed in different order and/or in parallel.

In step 610, a user device transmits, to an orchestration function, a service description for a service to be deployed over at least one infrastructure of a plurality of infrastructures.

The service description may include a plurality of software components to be deployed for providing the service.

At least one of the plurality of software components may be tagged in the service description as being a replicable component adapted to be replicated in two or more of the plurality of infrastructures.

In step 620, a user device requests a deployment of the plurality of software components in the at least one infrastructure on the basis of the service description in order to provide the service to one or more end devices.

The service description may include a performance estimation function to be evaluated over candidate instances of the plurality of software components and a set of end devices of interest in order to determine whether to replicate a replicable component and in which infrastructures.

The performance estimation function takes into account (i) candidate infrastructures assigned to the candidate instances and (ii) one or more infrastructures to which the end devices of interest are respectively connected.

It should be appreciated by those skilled in the art that any functions, engines, block diagrams, flow diagrams, state transition diagrams, flowchart and/or data structures described herein represent conceptual views of illustrative circuitry embodying the principles of the invention. Similarly, it will be appreciated that any flow charts, flow diagrams, state transition diagrams, pseudo code, and the like represent various processes.

Although a flow chart may describe steps of a method or process in a sequential manner, many of the steps may be performed in parallel, concurrently or simultaneously. Also some steps may be omitted, combined or performed in different order. A method or process may be terminated when its steps are completed but may also have additional steps not disclosed in the figure or description.

Each method, process, function, engine, block, step described herein can be implemented in hardware, software, firmware, middleware, microcode, or any suitable combination thereof.

When implemented in software, firmware, middleware or microcode, instructions to perform the necessary tasks of the method, process, function, engine, block, step may be stored in a computer readable medium that may be or not included in a computing device (or respectively a computing system) configured to execute the instructions. The instructions may be transmitted over the computer-readable medium and be loaded onto the computing device (or respectively computing system). The instructions are configured to cause the computing device (or respectively computing system) to perform one or more functions disclosed herein. For example, as mentioned above, at least one memory may include or store instructions, the at least one memory and the instructions may be configured to, with at least one processor, cause the computing device (or respectively computing system) to perform the one or more functions.

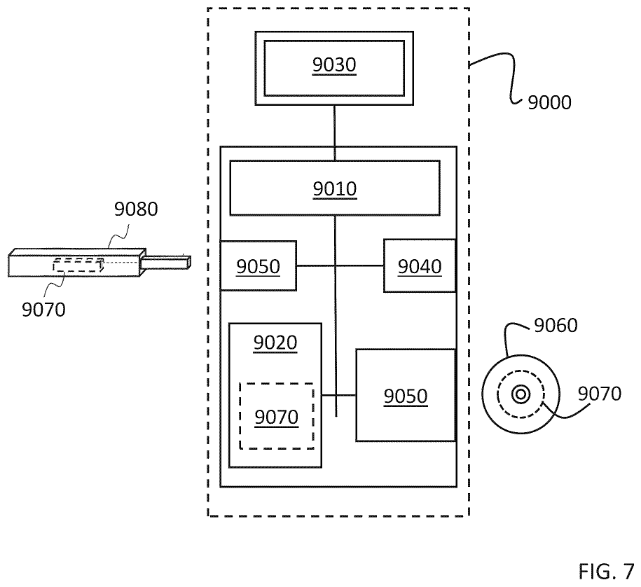

FIG. 7 illustrates an example embodiment of an apparatus 9000, as an example of computing device, computing node or end device or user device as disclosed herein. The apparatus 9000 may be configured to perform one or more functions of an orchestration function or user device as disclosed herein. The apparatus 9000 may be configured to perform one or more or all steps of any method or process disclosed herein.

A computing node may be a stand-alone computing device or a distributed computing system which is interconnected via one or more communication links (e.g., through a network) to one or more other computing nodes.

As represented schematically, the apparatus 9000 may include at least one processor 9010 and at least one memory 9020. The apparatus 9000 may include one or more communication interfaces 9040 (e.g., network interfaces for access to a wired/wireless network, including Ethernet interface, WIFI interface, etc) connected to the processor and configured to communicate via wired/non wired communication link(s). The apparatus 9000 may include user interfaces 9030 (e.g., keyboard, mouse, display screen, etc) connected with the processor. The apparatus 9000 may further include one or more media drives 9050 for reading a computer-readable storage medium (e.g., digital storage disc 9060 (CD-ROM, DVD, Blue Ray, etc), USB key 9080, etc). The processor 9010 is connected to each of the other components 9020, 9030, 9040, 9050 in order to control operation thereof.

The memory 9020 may be or include a random-access memory (RAM), cache memory, non-volatile memory, backup memory (e.g., programmable or flash memories), read-only memory (ROM), a hard disk drive (HDD), a solid-state drive (SSD) or any combination thereof. The ROM of the memory 9020 may be configured to store, amongst other things, an operating system of the apparatus 9000 and/or one or more computer program code of one or more software applications. The RAM of the memory 9020 may be used by the processor 9010 for the temporary storage of data.

The processor 9010 may be configured to store, read, load, execute and/or otherwise process instructions 9070 stored in a computer-readable storage medium 9060, 9080 and/or in the memory 9020 such that, when the instructions are executed by the processor, causes the apparatus 9000 to perform one or more or all steps of a method described herein for the concerned apparatus 9000.

The instructions may correspond to program instructions or computer program code. The instructions may include one or more code segments. A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

When provided by a processor, the functions may be provided by a single dedicated processor, by a single shared processor, or by a plurality of individual processors, some of which may be shared. The term “processor” should not be construed to refer exclusively to hardware capable of executing software and may implicitly include one or more processing circuits, whether programmable or not. A processor or likewise a processing circuit may correspond to a digital signal processor (DSP), a network processor, an application specific integrated circuit (ASIC), a field programmable gate array (FPGA), a System-on-Chips (SoC), a Central Processing Unit (CPU), an arithmetic logic unit (ALU), a programmable logic unit (PLU), a processing core, a programmable logic, a microprocessor, a controller, a microcontroller, a microcomputer, a quantum processor, any device capable of responding to and/or executing instructions in a defined manner and/or according to a defined logic.

A computer readable medium or computer readable storage medium may be any tangible storage medium suitable for storing instructions readable by a computer or a processor. A computer readable medium may be more generally any storage medium capable of storing and/or containing and/or carrying instructions and/or data. The computer readable medium may be a non-transitory computer readable medium. The term “non-transitory”, as used herein, is a limitation of the medium itself (i.e., tangible, not a signal) as opposed to a limitation on data storage persistency (e.g., RAM vs. ROM).

A computer-readable medium may be a portable or fixed storage medium. A computer readable medium may include one or more storage device like a permanent mass storage device, magnetic storage medium, optical storage medium, digital storage disc (CD-ROM, DVD, Blue Ray, etc), USB key or dongle or peripheral, a memory suitable for storing instructions readable by a computer or a processor.

A memory suitable for storing instructions readable by a computer or a processor may be for example: read only memory (ROM), a permanent mass storage device such as a disk drive, a hard disk drive (HDD), a solid-state drive (SSD), a memory card, a core memory, a flash memory, or any combination thereof.

In the present description, the wording “means configured to perform one or more functions” or “means for performing one or more functions” may correspond to one or more functional blocks comprising circuitry that is adapted for performing or configured to perform the concerned function(s). The block may perform itself this function or may cooperate and/or communicate with other one or more blocks to perform this function. The “means” may correspond to or be implemented as “one or more modules”, “one or more devices”, “one or more units”, etc.

The means may include at least one processor and at least one memory including at least one memory storing instructions that, when executed by the at least one processor, cause the apparatus to the considered function(s). The means may include circuitry (e.g., processing circuitry) configured to perform the considered function(s).

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, an integrated circuit for a network element or network node or any other computing device or network device.

The term circuitry may cover digital signal processor (DSP) hardware, network processor, application specific integrated circuit (ASIC), field programmable gate array (FPGA), etc. The circuitry may be or include, for example, hardware, programmable logic, a programmable processor that executes software or firmware, and/or any combination thereof (e.g., a processor, control unit/entity, controller) to execute instructions or software and control transmission and receptions of signals, and a memory to store data and/or instructions.

The circuitry may also make decisions or determinations, generate frames, packets or messages for transmission, decode received frames or messages for further processing, and other tasks or functions described herein. The circuitry may control transmission of signals or messages over a radio network, and may control the reception of signals or messages, etc., via one or more communication networks.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

While aspects of the present disclosure have been particularly shown and described with reference to the embodiments above, it will be understood by those skilled in the art that various additional embodiments may be contemplated by the modification of the disclosed devices, systems and methods without departing from the scope of what is disclosed. Such embodiments should be understood to fall within the scope of the present disclosure as determined based upon the claims and any equivalents thereof.

1. A method comprising:
receiving, by an orchestration function, a service description for a service to be deployed over at least one infrastructure of a plurality of infrastructures having respective access points, wherein the service description includes a plurality of software components to be deployed for providing the service, wherein at least one of the plurality of software components is tagged in the service description as being a replicable component adapted to be replicated in two or more of the plurality of infrastructures;
orchestrating, by the orchestration function, a deployment of the plurality of software components in the at least one infrastructure on the basis of the service description in order to provide the service to a plurality of end devices;
wherein orchestrating the deployment includes determining whether to replicate a replicable component and in which infrastructures based on a performance estimation function evaluated for a set of end devices of interest and candidate instances of the plurality of software components;
wherein the performance estimation function varies in dependence of (i) candidate infrastructures selected among the plurality of infrastructures for deploying the candidate instances and (ii) one or more infrastructures to which the end devices of interest are respectively connected via an access point to access the service deployed using the candidate instances.

2. The method of claim 1,
wherein the performance estimation function is evaluated based on performance estimates obtained respectively for the candidate instances,
wherein a performance estimate for a given candidate instance of a software component to be deployed in a candidate infrastructure varies in dependence upon the candidate infrastructure in which the given candidate instance is to be deployed and the one or more infrastructure to which the one or more end devices of interest to be served by the given candidate instance are respectively connected.

3. The method of claim 2, wherein the performance estimate for the given candidate instance varies in dependence upon at least one performance metric, the at least one performance metric including a distance between the end device of interest and the given candidate instance to be deployed for serving the end device of interest.

4. The method of claim 1, wherein the service description defines the performance estimation function.

5. The method of claim 1, wherein orchestrating the deployment of the plurality of software components comprises:
selecting respective locations in candidate infrastructures for deploying the candidate instances of the plurality of software components for providing the service to the set of end devices of interest, wherein selecting the respective locations is performed so as to meet performance requirements based on the performance estimation function.

6. The method of claim 5, wherein selecting the respective locations comprises:
generating sets of candidate instances adapted for providing the service to end devices of interest, wherein each of the sets of candidate instances comprises one or more candidate instances for each replicable component in the plurality of software components and only one candidate instance for each non-replicable component in the plurality of software components, wherein a candidate instance in a set of candidate instances is assigned to at least one of the end devices of interest to be served by the considered candidate instance;
generating a performance estimate for each candidate instance in the sets of candidate instances and the one or more end devices of interest to be served by the considered candidate instance;
selecting one of the sets of candidate instances for which the performance estimates of the candidate instances in the considered set of candidate instances meet the performance requirements;
deploying the service using the candidate instances of the selected set of candidate instances.

7. The method of claim 1, wherein the service description defines one set of at least one end device of interest for the plurality of software components.

8. The method of claim 1,
wherein the service description defines a set of end devices of interest per replicable software component and an associated performance estimation function;
wherein the performance estimation function is evaluated independently for each replicable component over candidate instances of the considered replicable component for serving the considered set of end devices of interest.

9. The method of claim 1, comprising determining whether to replicate a replicable component or delete an instance of a replicable component in response to a detection of at least one of the following triggers: a connection to an infrastructure of an end device of interest, a disconnection from an infrastructure of an end device of interest, a change of access point for an end device of interest, an update of the definition of the set of end devices of interest,
wherein determining whether to replicate a replicable component or delete an instance of a replicable component is performed based on results of the performance estimation function evaluated after the detection of the at least one trigger.

10. The method of claim 1, comprising evaluating the performance estimation function in response to a detection of at least one of the followings changes: a connection to an infrastructure of an end device of interest, a disconnection from an infrastructure of an end device of interest, a change of access point for an end device of interest, an update of the definition of the set of end devices of interest, an update of a definition of the performance estimation function, an update in the plurality of software components to de deployed for providing the service;
determining whether to replicate a replicable component or delete an instance of a replicable component based on results of the evaluation of the performance estimation function.

11. A method comprising:
transmitting, to an orchestration function, a service description for a service to be deployed over at least one infrastructure of a plurality of infrastructures, wherein the service description includes a plurality of software components to be deployed for providing the service, wherein at least one of the plurality of software components is tagged in the service description as being a replicable component adapted to be replicated in two or more of the plurality of infrastructures;
requesting a deployment of the plurality of software components in the at least one infrastructure on the basis of the service description in order to provide the service to one or more end devices, the service description including a performance estimation function to be evaluated over candidate instances of the plurality of software components and a set of end devices of interest in order to determine whether to replicate a replicable component and in which infrastructures;
wherein the performance estimation function takes into account (i) candidate infrastructures selected among the plurality of infrastructures for deploying the candidate instances and (ii) one or more infrastructures to which the end devices of interest are respectively connected via an access point to access the service deployed using the candidate instances.

12. An apparatus comprising
at least one processor;
at least one memory storing instructions that, when executed by the at least one processor, cause the apparatus to carry out:
receiving, by an orchestration function, a service description for a service to be deployed over at least one infrastructure of a plurality of infrastructures having respective access points, wherein the service description includes a plurality of software components to be deployed for providing the service, wherein at least one of the plurality of software components is tagged in the service description as being a replicable component adapted to be replicated in two or more of the plurality of infrastructures;
orchestrating, by the orchestration function, a deployment of the plurality of software components in the at least one infrastructure on the basis of the service description in order to provide the service to a plurality of end devices;
wherein orchestrating the deployment includes determining whether to replicate a replicable component and in which infrastructures based on a performance estimation function evaluated for a set of end devices of interest over candidate instances of the plurality of software components;
wherein the performance estimation function varies in dependence of (i) candidate infrastructures selected among the plurality of infrastructures for deploying the candidate instances and (ii) one or more infrastructures to which the end devices of interest are respectively connected via an access point to access the service deployed using the candidate instances.

13. The apparatus of claim 12,
wherein the performance estimation function is evaluated based on performance estimates obtained respectively for the candidate instances,
wherein a performance estimate for a given candidate instance of a software component to be deployed in a candidate infrastructure varies in dependence upon the candidate infrastructure in which the given candidate instance is to be deployed and the one or more infrastructure to which the one or more end devices of interest to be served by the given candidate instance are respectively connected.

14. The apparatus of claim 13, wherein the performance estimate for the given candidate instance varies in dependence upon at least one performance metric, the at least one performance metric including a distance between the end device of interest and the given candidate instance to be deployed for serving the end device of interest.

15. The apparatus of claim 12, wherein the service description defines the performance estimation function.

16. The apparatus of claim 12, wherein orchestrating the deployment of the plurality of software components comprises:
selecting respective locations in candidate infrastructures for deploying the candidate instances of the plurality of software components for providing the service to the set of end devices of interest, wherein selecting the respective locations is performed so as to meet performance requirements based on the performance estimation function.

17. The apparatus of claim 16, wherein selecting the respective locations comprises:
generating sets of candidate instances adapted for providing the service to end devices of interest, wherein each of the sets of candidate instances comprises one or more candidate instances for each replicable component in the plurality of software components and only one candidate instance for each non-replicable component in the plurality of software components, wherein a candidate instance in a set of candidate instances is assigned to at least one of the end devices of interest to be served by the considered candidate instance;
generating a performance estimate for each candidate instance in the sets of candidate instances and the one or more end devices of interest to be served by the considered candidate instance;
selecting one of the sets of candidate instances for which the performance estimates of the candidate instances in the considered set of candidate instances meet the performance requirements;
deploying the service using the candidate instances of the selected set of candidate instances.

18. The apparatus of claim 12, wherein the service description defines one set of at least one end device of interest for the plurality of software components.

19. The apparatus of claim 12,
wherein the service description defines a set of end devices of interest per replicable software component and an associated performance estimation function;
wherein the performance estimation function is evaluated independently for each replicable component over candidate instances of the considered replicable component for serving the considered set of end devices of interest.

20. The apparatus of claim 12, wherein the apparatus is further caused to carry out:
determining whether to replicate a replicable component or delete an instance of a replicable component in response to a detection of at least one of the following triggers: a connection to an infrastructure of an end device of interest, a disconnection from an infrastructure of an end device of interest, a change of access point for an end device of interest, an update of the definition of the set of end devices of interest,
wherein determining whether to replicate a replicable component or delete an instance of a replicable component is performed based on results of the performance estimation function evaluated after the detection of the at least one trigger.
